(19) United States
(12) Patent Application Publication
(10) Pub. No.: US 2005/0190686 A1
(43) Pub. Date: Sep. 1, 2005

(54) Recordable optical disc and method for manufacturing a mother disc thereof

(76) Inventors: Wu-Hsuan Ho, Hsinchu (TW); Chung-Ping Wang, Hsinchu (TW); Yi-Chen Chung, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/788,359

(22) Filed: Mar. 1, 2004

(51) Int. Cl. G11B 7/24

(52) U.S. Cl. 369/275.4; 369/275.2

(57) ABSTRACT

A recordable optical disc and a method for manufacturing a mother disc thereof are proposed. The recordable optical disc comprises a substrate with a spiral groove wobbled in a fixed period. The recordable optical disc is characterized in that the spiral groove has a plurality of transient side-wobble regions not in the wobble period and used as recording regions of address data. In the method of manufacturing a mother disc of the optical disc, a spiral groove is first formed on a mother disc substrate by using an etching source wobbling in a fixed period. A transient side-wobble not in the wobble period is inserted between several wobble periods to form a spiral groove having transient side-wobble regions on the mother disc substrate. The stability of manufacture of the mother disc can thus be greatly enhanced, and the PI error rate of the optical disc can be lowered.

### FIELD OF THE INVENTION

The present invention relates to an optical disc and, more particularly, to a recordable optical disc and a method for manufacturing a mother disc thereof.

### BACKGROUND OF THE INVENTION

Read/write of a magnetic disc is accomplished in a constant angular velocity (CAV) way. That is, the rotation speed of a magnetic disc drive is kept constant, while the read/write speed differs. Therefore, data are distributed in sections, and the density of magnetic sectors at the outer circle is higher. Different from the CAV read/write way of magnetic recording media, recordable optical discs and common stamped optical discs adopt a constant linear velocity (CLV) way to record or read data, regardless of the positions of data on the optical discs. In other words, data signals are recorded connectedly, and the rotation speed of the optical disc depends on the position of the pick-up head. The closer the pick-up head to the periphery of an optical disc, the slower the rotation speed of the optical disc. In order to accomplish this object, it is necessary to pre-record tracking and timing data on an optical disc for guiding the laser light beam of the optical disc drive to move outwards in proper sequence and accurately control the rotation speed of the optical disc drive.

A conventional optical disc comprises a substrate with a spiral wobble groove formed outwards from the center of the substrate to make grooves 10 and lands 12 on the substrate, as shown in FIG. 1. This preformed wobble groove has a specific period to provide tracking and timing data for guiding the laser light beam of the optical disc drive to move outwards in proper sequence and also let an optical disc recorder keep a constant recording speed according to this specific period. In addition to these tracking and timing data, it is also necessary to preform recording regions of address data on the optical disc. In the prior art, many pits 14 are preformed at specific positions on the flat lands 12 for recording address data of the optical disc so called Land Pre-pit.

Usually, optical discs are produced in large quantities using a mother disc through the injection molding technology. The above wobble groove is formed on the mother disc using a laser light beam. However, because the preformed pits 14 are located on the lands 12 and are uneven with the grooves 10, the focusing position and spot size of the laser light beam are difficult to control when manufacturing the mother disc, hence causing deviation of the position, size and shape of the pits 14. Moreover, the strength of the address signals of the formed optical disc will differ due to inaccuracy of the pits so that interference may easily occur when an optical disc drive reads the groove data of the optical disc.

Accordingly, the present invention aims to propose a recordable optical disc with address signal regions disposed at a preformed groove to solve the above problems in the prior art.

### SUMMARY OF THE INVENTION

The primary object of the present invention is to provide a recordable optical disc and a method for manufacturing a mother disc thereof. A plurality of transient side-wobble regions as recording regions of address data are provided at a spiral wobble groove so that a single laser light beam can be used to accomplish the manufacture of a mother disc of an optical disc, thereby effectively solving the problems of position deviation of address data and difficult focusing in the prior art and further greatly enhancing the stability in the manufacture of the mother disc.

Another object of the present invention is to provide an address data recording structure of a recordable optical disc. Transient side-wobble regions of a groove are used to record address data for effectively lowering the PI error rate of the optical disc.

Another object of the present invention is to provide a method for manufacturing a mother disc of a recordable optical disc. Recording regions of address data are simultaneously formed on a groove when formed a spiral groove on the mother disc to accomplish the advantages of high yield and easy manufacture of the mother disc.

According to the present invention, a recordable optical disc comprises a substrate with a spiral groove formed thereon. The spiral groove is formed by connecting a plurality of sub-wobble-grooves in a fixed wobble period. The optical disc is characterized in that the spiral groove has a plurality of transient side-wobble regions not in the wobble period and used as recording regions of address data. In the method of manufacturing a mother disc of the recordable optical disc, a substrate is first provided. Next, a spiral groove is formed outwards from the center of the substrate by an etching source wobbling in a fixed period. The wobbling way of the etching source is that a transient side-wobble not in the wobble period is inserted between several wobble periods so as to form a spiral groove having a plurality of transient side-wobble regions on the substrate.

The various objects and advantages of the present invention will be more readily understood from the following detailed description when read in conjunction with the appended drawing, in which:

### BRIEF DESCRIPTION OF THE DRAWINGS

FIG. 1 is a structure diagram of a conventional optical disc.

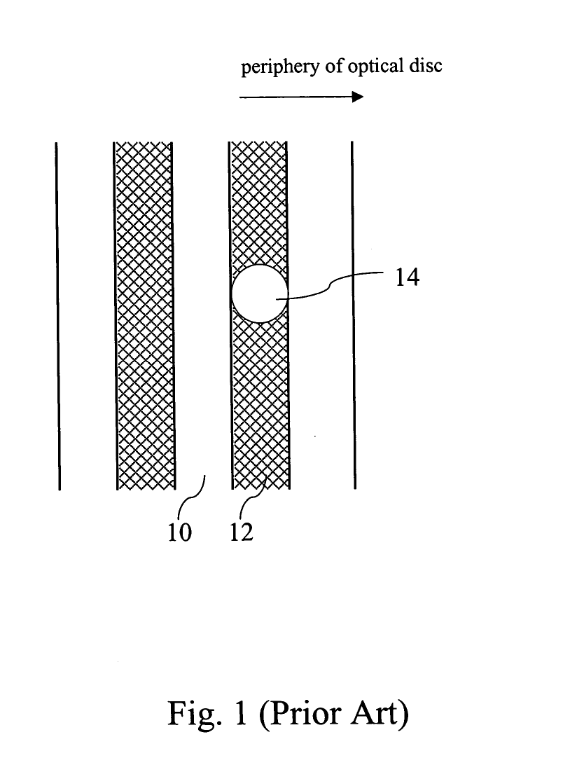

FIG. 2 is a partly enlarged diagram of an optical disc of the present invention; and

FIG. 3 is a flowchart diagram for manufacturing a mother disc of the present invention.

### DETAILED DESCRIPTION OF THE PREFERRED EMBODIMENTS

It is necessary to pre-record tracking and timing data on a recordable optical disc for guiding the laser light beam of an optical disc drive to move outwards from the center of the optical disc in proper sequence. This is accomplished through a preformed wobble groove. Besides, it is also necessary to preform recording regions of address data on an optical disc. In the present invention, the center line of the wobble groove is transiently wobbled to generate a wobble groove having transient side-wobble regions for recording the address data.

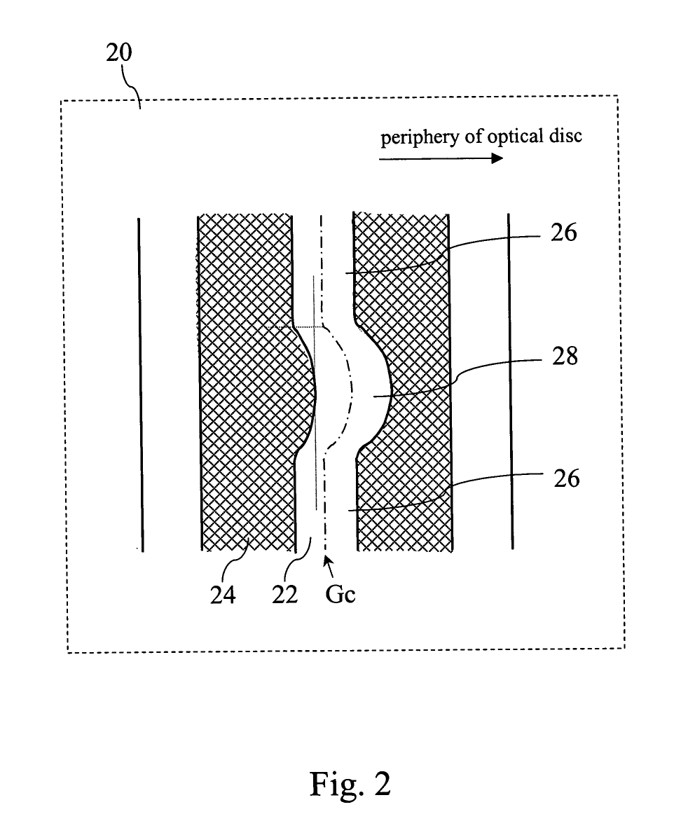

As shown in FIG. 2, a recordable optical disc of the present invention comprises a circular substrate 20 with a shallow spiral groove formed outwards thereon from the center to form grooves 22 and lands 24 spaced in-between. The spiral groove is formed by connecting a plurality of sub-wobble-grooves 26 in a fixed period (wobble of the groove 22 is not shown). A plurality of transient side-wobble regions 28 not in the wobble period are inserted between these sub-wobble-grooves 26. These transient side-wobble regions are formed by transiently wobbling the center line of the groove 22 and are used as recording regions of address data.

The accommodation way of the periodic sub-wobble-grooves 26 and the transient side-wobble regions 28 on the spiral groove can be flexibly changed in design. Speaking in more detail, a transient side-wobble region 28 can be provided with several sub-wobble-grooves 26 as the unit. With a DVD-R/RW disc as the example, one to three transient side-wobble regions 28 are provided with sixteen of the sub-wobble-grooves 26 as the unit. That is, one to three transient side-wobble regions 28 used as address recording regions are provided for every sixteen of the sub-wobble-grooves 26.

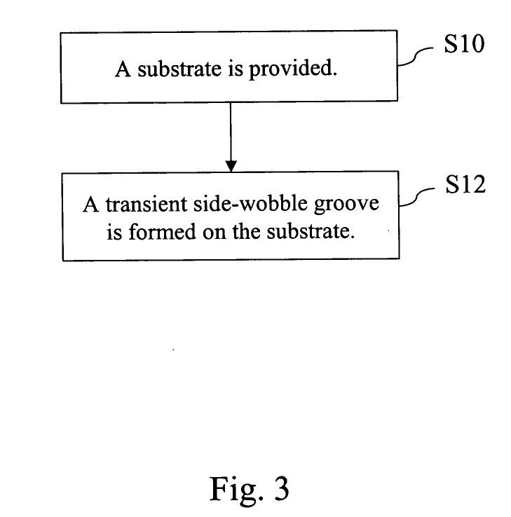

The above optical discs are usually produced in large quantities using a mother disc through the injection molding technology. The mother disc is manufactured using a laser beam recorder. As shown in FIG. 3, the method for manufacturing a mother disc of the recordable optical disc comprises the following two steps. A substrate is first provided (Step S10). The material of the substrate is preferred to be glass. Next, a laser light beam set by a program in advance is used to form a shallow spiral groove on the surface of the substrate. The laser light beam is used in a fixed wobble period to form the spiral groove on the substrate outwards from the center of the substrate. The wobbling way of the laser light beam is that a transient side-wobble not in the wobble period is inserted between several wobble periods. In other words, the laser light beam is transiently wobbled when moving in a periodic wobble way through program setting. A spiral groove having transient side-wobble regions is thus formed on the substrate to make a mother disc of the optical disc.

The way of transiently wobbling a laser light beam is accomplished by externally connecting a laser beam recorder with a transistor-transistor logic (TTL) circuit and through an electronic optical deflector (EOD).

After manufacture of the mother disc is finished, the mother disc can be used for mass production of the optical disc. Usually, polycarbonate is used as the material for producing the optical disc through the injection molding technology. After injection, molding, cooling and hardening of material, the optical disc can be formed. The microscopic structure of this optical disc is shown in FIG. 2.

In the above method of forming transient side-wobble regions for recording address data on a wobble groove, because marks are made at positions of the groove requiring addresses in a transient wobble way, a single laser light beam can be continuously used to form the spiral groove as well as recording regions of address data. Therefore, only a single laser light beam is required in the present invention for manufacturing a mother disc of the optical disc, hence solving the problems of difficult focusing and position deviation of the laser light beam in the prior art and further greatly enhancing the stability in the manufacture of the mother disc. Moreover, the PI error rate of the optical disc duplicated with the mother disc can be lowered.

To verify the effect of the present invention, the address signal strength and the PI error rate of optical discs manufactured by the conventional technique and the present invention are compared with the results shown in Table 1 below. In Table 1, the address signal strength is obtained by [address signal strength]/[reflectance], and the unit is [mv/mv], hence having no unit. From the measurement results, one can know that the address signal strength won't deteriorate due to change of the manufacturing way of the mother disc in the present invention. Besides, there is usually an error correction mechanism for digital data. The PI error rate represents the error rate before error correction. If it is smaller than 10⁻³, the final reading error rate will approach zero. From the measurement results, one can know that the present invention can improve the PI error rate from 10⁻³ in the prior art to 10⁻⁴ to have the advantage of more stable read/write of data.

| | | Conventional | Groove with transient |
|---|---|---|---|
| | Standard | preformed pits | side-wobble regions of |
| | specification | on the lands | the present invention |
| Address | 0.18˜0.28 | 0.18˜0.28 | 0.18˜0.28 |
| signal | | (depending | (depending |
| strength | | on the shape) | on the shape) |
| PI error | <1 × 10⁻³ | 0.2˜3 × 10⁻³ | 1 × 10⁻⁴ |
| rate | | (unstable) | (stable) |

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A recordable optical disc comprising a substrate having a spiral groove, said spiral groove being composed of a plurality of sub-wobble-grooves wobbled in a fixed period and connected together, said recordable optical disc being characterized in that said spiral groove has a plurality of transient side-wobble regions not in the wobble period and used as recording regions of address data.

2. The recordable optical disc as claimed in claim 1, wherein at least one of said transient side-wobble regions is provided with a plurality of said sub-wobble-grooves as a unit.

3. The recordable optical disc as claimed in claim 2, wherein at least one said transient side-wobble region is provided with sixteen of said sub-wobble-grooves as the unit.

4. The recordable optical disc as claimed in claim 1, wherein said transient side-wobble region is formed by transiently wobbling the center line of said spiral groove.

5. A method for manufacturing a mother disc of a recordable optical disc, said method comprising the steps of:
providing a substrate; and
forming spirally and outwards a groove wobbled in a fixed period on said substrate from the center thereof by using an etching source with a transient side-wobble inserted between several wobble periods to form a spiral groove having a plurality of transient side-wobble regions so that said substrate can be used as a mother disc for subsequent duplication of optical discs.

6. The method for manufacturing a mother disc of a recordable optical disc as claimed in claim 5, wherein said etching source is a laser light.

7. The method for manufacturing a mother disc of a recordable optical disc as claimed in claim 5, wherein a single laser light beam is continuously used to form said spiral groove.

8. The method for manufacturing a mother disc of a recordable optical disc as claimed in claim 7, wherein said laser light beam is transiently wobbled to form said transient side-wobble regions.

9. The method for manufacturing a mother disc of a recordable optical disc as claimed in claim 5, wherein said transient side-wobble regions are formed by transiently wobbling the center line of said spiral groove.

10. The method for manufacturing a mother disc of a recordable optical disc as claimed in claim 5, wherein the material of said substrate is glass.
